(19) United States
(12) Patent Application Publication
(10) Pub. No.: US 2017/0285208 A1
(43) Pub. Date: Oct. 5, 2017

(54) Magnetic Force Reducer

(71) Applicant: Baker Hughes Incorporated, Houston, TX (US)

(72) Inventors: Homero C. Castillo, Kingwood, TX (US); Otto N. Fanini, Houston, TX (US)

(21) Appl. No.: 15/088,954

(22) Filed: Apr. 1, 2016

(51) Int. Cl. G01V 3/08; E21B 49/00

(52) U.S. Cl. CPC G01V 3/08; E21B 49/00

(57) ABSTRACT

A downhole tool includes a housing, a permanent magnet in the housing, and magnetic field source that selectively generates a magnetic field which counters a magnetic field generated by the permanent magnet. The downhole tool is deployed in a wellbore that intersects a subterranean formation, and is used for imaging the formation. The magnetic field source can be a coil through which an electrical current is selectively conducted. The electrical current can be continuously applied or pulsed through the coil.

### BACKGROUND OF THE INVENTION

### 1. Field of Invention

The present disclosure relates to wellbore operations. More specifically, the present disclosure relates to a system and method for countering electromagnetic forces that attract a downhole tool and tubular.

### 2. Description of Prior Art

Downhole tools are typically used to gather information about hydrocarbon bearing subterranean formations by deploying the tools inside of a wellborn that intersects the formation. The information gathered regarding is often used to estimate the location and amounts of hydrocarbon reserves within the formation. The information generally includes permeability, porosity, bound fluid volume, formation pressure and temperature, and resistivity. Estimates of one or more of these borehole parameters in a specific formation can be made by emitting signals from logging instruments provided with the downhole tool.

Some logging instruments include permanent magnets, and when the downhole tool is inserted within downhole tubulars, such as tubing or casing made of ferromagnetic material, the magnets sometimes generate an attractive force that urges the housing of the downhole tool against the inner surface of the tubular. The magnetic attraction forces between the magnet and tubular increases sliding friction between the tool housing and the tubular as the tool is being raised or lowered within the tubular. The increased friction increases wear on the tool housing, and in some instances can cause downhole tool to adhere to the inner wall of the tubular; which interferes with downhole operations if the downhole tool is being lowered on a wireline or cable.

### SUMMARY OF THE INVENTION

Disclosed herein are examples of systems and methods of operating in a wellbore. One example of a method of operating in a wellbore includes providing a downhole tool having a housing and a permanent magnet, deploying the downhole tool in the wellbore and within a tubular inserted in the wellbore so that a first magnetic field formed by the permanent magnet generates a force that attracts the downhole tool and the tubular inner surface and selectively countering the first magnetic field with a second magnetic field to reduce the force that attracts the housing with the tubular inner surface. The second magnetic field can have a magnetic moment with the same magnitude as a magnetic moment of the first magnetic field and oriented in an opposite direction. In one example, the second magnetic field has a magnetic moment with a lesser magnitude as a magnetic moment of the first magnetic field and oriented in an opposite direction. The second magnetic field can be formed by selectively flowing current through a coil along a helical path. The force generated by the first magnetic field can adhere the housing with the tubular inner surface when in a deviated portion of the wellbore. The method can further include imaging within the borehole using the downhole tool. In this example, imaging can be nuclear magnetic resonance imaging, acoustic imaging, flux leakage imaging, and combinations thereof. The downhole tool can optionally be deployed on wireline.

Another example method of operations in a wellbore includes operating, inside of the wellbore, a downhole tool that is made up of a housing and a source of a first magnetic field within the housing, moving the downhole tool within tubing that is inserted in the wellbore, so that the first magnetic field generates an attractive force between the downhole tool and an inner surface of the tubular, and selectively forming a second magnetic field which counters the attractive force between the downhole tool and inner surface of die tubular. The source for the first magnetic field can be a permanent magnet. The second magnetic field can be formed by flowing electrical current along a helical path. The method can further include imaging a formation that surrounds the wellbore with an imaging system within the downhole tool.

Yet another example of a method of operating in a wellbore includes providing a downhole tool having a housing and at least one permanent magnet represented by a net magnetic moment strength and deploying the downhole tool in the wellbore and within a tubular inserted in the wellbore. A first spontaneous magnetic field formed by the permanent magnet aligns the elemental magnetic domains in the tubular material therefore exhibiting a resulting induced net secondary magnetic moment in the tubular. Both the net permanent and induced magnetic moments can be represented by magnetic dipoles which interact generating a net attractive force between the downhole tool and the tubular in the case there is asymmetry of spatial distribution of the magnetic moments in an around the tubular specially when the tool is not centralized within the tubular. Selectively countering or cancelling within the downhole tool extension the permanent magnet's first magnetic dipole moment field with a controlled second magnetic dipole moment field consequently reducing the net secondary magnetic dipole moment induced in the tubular. The net strength cancellation and reduction of both interacting permanent and secondary magnetic dipoles from the tool and the tubular can substantially reduce the attractive force between the tool housing with the tubular structures. The second controlled magnetic dipole field can have a magnetic moment with the same magnitude as a magnetic dipole moment of the first magnetic field and oriented in an opposite direction. The second controlled magnetic dipole field polarity and intensity can be manipulated to reduce attractive forces to release the tool or increase attractive forces to lock the tool in place by increased friction. In one example, the second magnetic field has a magnetic moment with a lesser magnitude as a magnetic moment of the first magnetic field and oriented in an opposite direction. The second magnetic field can be formed by selectively flowing current through a coil along a helical path distributed along the extension of the permanent magnet in the downhole tool. The resulting attractive force resulting from the first magnetic field can adhere the housing with the tubular inner surface when in a deviated portion of the wellbore, with friction forces increased by the tool weight. The method can further include using downhole instrumentation involving formation evaluation, imaging, casing, and cement inspection, through casing measurements within the borehole using the downhole tool. A downhole tool as it is deployed downhole from the surface traverses a section of cased well before it reaches the open borehole section where its deployment can be difficult due to friction forces augmented by the permanent magnet's interaction with the tubular. Imaging can be nuclear magnetic resonance imaging, transient electromagnetic tool, induction tool, magnetometers, acoustic and resistivity imaging, magnetic flux leakage imaging, and combinations thereof. The downhole tool can optionally be deployed on wireline, drilling bottom hole assembly, coil tubing, subsea intervention and other deployment methods.

Also described herein is an example of a downhole tool for use in a wellbore, where the downhole tool includes a housing, a permanent magnet that forms a first magnetic field, and an electromagnetic field source that selectively forms a second magnetic field which counters the first magnetic field. The downhole tool can further include a plurality of permanent magnets and a plurality of electromagnetic field sources. The electromagnetic field source can be made up of a coil of conductive material that forms a helical path for a flow of electrical current. The coil can have a geometric extension that is similar to that of the permanent magnet, and a geometric form factor that follows that of the permanent magnet. Optionally, the housing attaches to wireline which supports the downhole tool within the wellbore.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side partial sectional view of an example of a downhole tool in a wellbore and having a magnetic held source.

FIG. 2 is a side partial sectional view of an example of the downhole tool of FIG. 1 with the magnetic field source activated.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in winch embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of the cited magnitude. In an embodiment usage of the term “substantially” includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

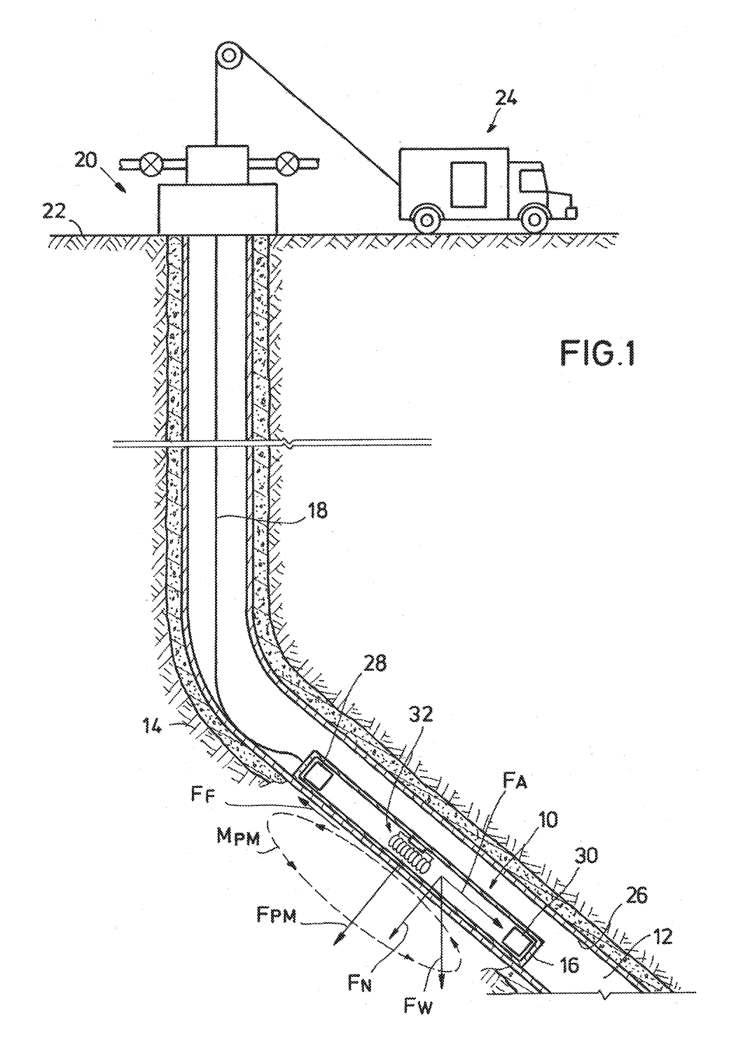

An example of a downhole tool 10 is shown in a partial side sectional view in FIG. 1. In the example shown, downhole tool 10 is disposed in a deviated portion of a wellbore 12, and which intersects a subterranean formation 14. Downhole tool 10 includes an outer housing 16 and in which its various components of the downhole tool 10 are disposed. An upper end of housing 16 is shown attached to a wireline 18, which extends upward within wellbore 12 and threads through a wellhead assembly 20 shown mounted over the opening of wellbore 12 and on surface 22. An upper end of cable 18 makes its way into a surface truck 24, which is on surface 22, and in which a reel (not shown) can be operated to raise and lower cable 18 thereby moving the downhole tool 10 to different depths within wellborn 12. Moreover, a controller (not shown) may be disposed within surface truck 24 and which communicates with downhole tool 10, such as by providing command signals to downhole tool 10, or receiving data or other information from downhole tool 10. Cable 18 may also be used for conducting electrical power to downhole tool 10 which powers components of downhole tool 10.

Wellbore 12 is lined with casing 26, which in an example is made from a ferromagnetic material and which can develop an attractive force when interacting between itself and magnets, such as permanent magnets. Downhole tool 10 can be used for various downhole operations, such as imaging the formation 14, assessing formation parameter, such as density, porosity, temperature, pressure and the like. Example instruments within the housing 16, or otherwise included or coupled to downhole tool 10, include a nuclear magnetic resonance tool, electromagnetic acoustic tools, devices with pads on the outer surface of housing 16, as well as tools for inspecting well integrity and integrity of casing 26. In some embodiments, arms (not shown) may be included with tool 10 that deploy radially outward from housing 16 and have measurement pads on their free end and which come into contact with the inner surface of casing 26. Optionally, tool 10 may be inserted within production tubing (not shown) which is inserted within wellbore 12. To help accomplish its imaging and casing inspection function, downhole tool 10 may be equipped with magnets, such as permanent magnets or electro magnets.

Still referring to FIG. 1, an example of a magnet pole 28 is shown provided with downhole tool 10, and another magnet pole 30 is shown provided with downhole tool 10 and axially spaced away from magnet pole 28. Optionally, the poles 28, 30 may have a different polarity. Further optionally, magnet pole 28 may be part the same magnet as magnet pole 30. In the example of FIG. 1, a magnetic field M_{PM} is shown formed between poles 28, 30. For the purposes of illustration herein, pole 28 in this example is considered a north pole, and pole 30 a south pole forming a magnetic dipole. As the casing 26 is formed from a ferromagnetic material, an attractive force F_{M} is shown which attracts the tool 10 up against the inner surface of casing 26. Moreover, in the illustrated example, the cable 18 is shown as being slack just above downhole tool 10. The slack cable 18 is an indication that the downhole tool 10 has become adhered to the casing 26 and tension in the cable 18 is unnecessary to maintain the downhole tool 10 at that particular depth. As a result of the magnetically induced attractive force F_{PM}, a resulting frictional force F_{F} is shown directed axially along the wellbore 12. Frictional force F_{F} as shown is aligned with contact interlace between the tool 10 and casing 26 so that frictional mechanical losses are developed mostly in an axial direction. Further illustrated is a force vector F_{W}, which represents the weight (W) of the downhole tool 10. Subcomponents F_{N} and F_{A} of force vector F_{W} respectively represent a normal (N) weight force against the sidewall of casing 26, and an axial force parallel with the local axis of well bore 12. As the deviation of the wellbore 12 increases (i.e. becomes more oblique to vertical), subcomponent F_{N} increases further contributing to the friction forces F_{F}. Accordingly, the friction force F_{F} resisting the downhole tool 10 movement inside casing 26 depends on the weight of the downhole tool 10, the magnitude of the magnetic field M_{PM}, in combination with the coefficient of friction μ between the downhole tool 10 and sidewall of casing. These values will dictate if the downhole tool 10 adheres to the sidewall casing 26, or can freely slide downward within casing 26. Similarly as the tool string is retrieved upwards, the relative intensities of the net friction force F_{F} and the opposing axial component F_{A} of the weight of the downhole tool 10 will dictate if the downhole tool 10 adheres to the sidewall casing 26, or can be pulled upwards by force applied to the downhole tool 10 by the wireline cable 18. If the tool string is being deployed with tractor assistance the maximum tractor force available to overcome the friction forces needs to be taken into account. Irrespective of whether or not the weight of the downhole tool 10 can overcome the force of magnet F_{M} and coefficient of friction μ, an attractive force F_{M} still exists due to presence of the magnetic dipoles 28, 30 disposed with the downhole tool 10.

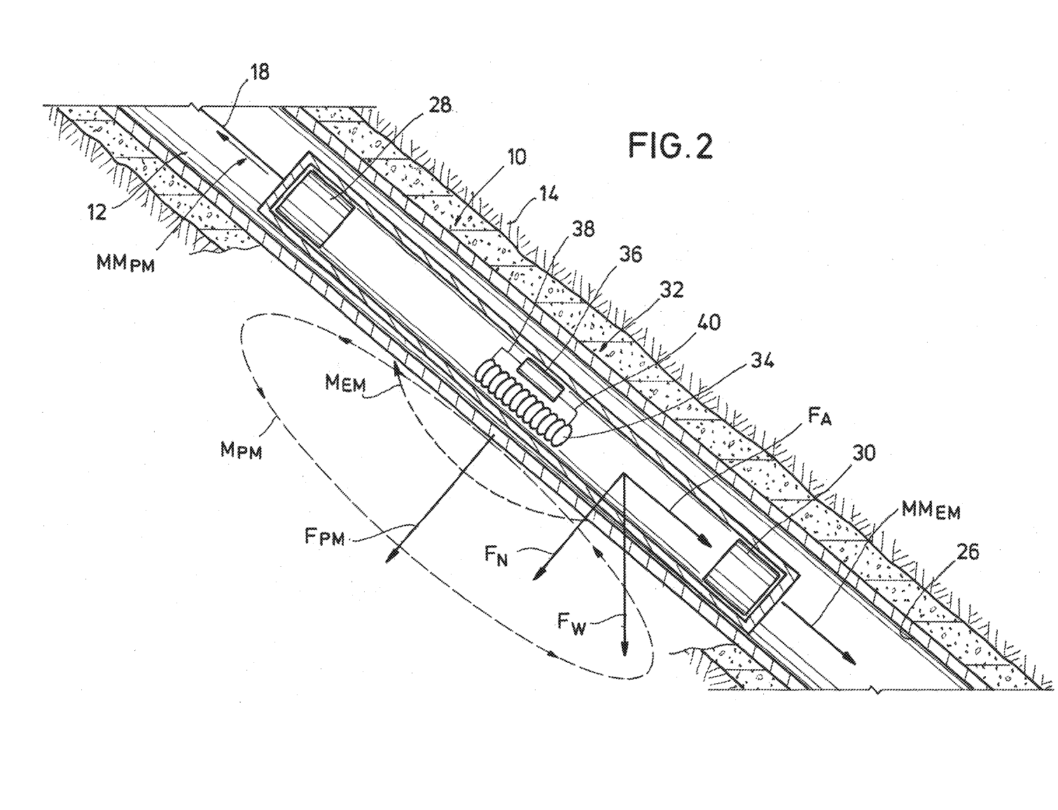

FIG. 2 shows in a side partial sectional view an example of the downhole tool 10 and where a magnetic held scarce 32 presided with downhole tool 10 is in an activated state. The example of the magnetic held source 32 of FIG. 2 includes a coil 34 which is made up of a length of electrically conductive material that is wound into a helix so that in the electricity conducted through the coil 34 will follow a helical path. In one example the magnetic field source 32 is an electromagnet. An optional power source 36 is shown connected to opposing ends of the coil 34 via leads 38, 40. Alternatively, electrical current flowing through the coil 34 may be provided via wireline 18 and from surface 22 (FIG. 1). In the activated state, electrical current flows through coils 34 and generates a magnetic held M_{EM} represented by the dashed arrow. As shown, the direction of M_{EM} is opposite to that of magnetic field M_{PM}. The current flow in coil 34 could be a direct current (DC) flow, an alternate current (AC) flow with sinusoidal or square waveforms for example or alternatively intermittent current flow. Current flow in coil 34 could have superimposed smaller variations including random variations to introduce smaller disturbances during tool 10 deployment motion. Strategically disposing the magnetic field source 32 in relation to poles 28, 30, and orienting the direction of the current flow through coils 34, forms the magnetic field M_{EM} that is in a direction opposite to magnetic field M_{PM}. Embodiments exist where the magnetic field M_{EM} is at least as great as the magnetic field M_{PM} thereby canceling the force F_{PM} of attraction between the downhole tool 10 and casing 26. Optionally, the magnetic field M_{EM} can be less than magnetic field M_{PM} thereby lessening the force F_{PM} thereby allowing sliding of the downhole tool 10, but yet still allowing a positive net force for F_{PM} to exist. Further illustrated in FIG. 2 is a magnetic moment MM_{EM}, which represents the magnetic dipole moment created by activation of the magnetic field source 32. In a direction opposite to magnetic moment MM_{EM}, magnetic dipole moment MM_{PM} is shown, which is generated by the magnetic field M_{PM} formed by the magnet poles 28, 30.

Optionally, multiple sets of magnet poles 28, 30 can be provided with downhole tool 10. In this example, a magnetic field source 32 may be provided with each set of magnet poles 28, 30. For the purposes of discussion herein, magnet poles 28, 20 are part of a permanent magnet, which defines in one example materials that can be magnetized by an external magnetic field and remain magnetized after the external field is removed. The magnets can be ferromagnetic, or ferrimagnetic. Example materials for the ferromagnetic substances include iron, nickel, cobalt, and their alloy combinations. In an alternative, the magnetic field source 32 has a similar geometric extension as the magnet or magnets making up the magnetic poles 28, 30 and also may cover the entire extension of the magnet. Moreover, the magnetic field source 32 follows the geometric form factor of the permanent magnet.

One alternate embodiment, ferromagnetic materials can be used in the construction of downhole tool 10 with fixed or moving parts. An example of fixed parts is the permanent magnet resolution presented by a magnetic dipole formed with poles 28 and 30 as shown in FIG. 1. An example of equipment with permanent magnets housed in moving parts are permanent magnets deployed as part of pad's construction used to survey the casing'inner surface deployed by articulating arms. Practical example of these survey pads with permanent magnets in their construction are implemented in the High Resolution Vertilog Tool (flux leakage detection due to casing imperfections) also known as HVRT and Electro-Magnet Acoustic Tool (EMAT) pads for cement inspection. Another option is to utilize a movement of parts formed by ferromagnetic or antiferromagnetic materials is to change the distribution of the magnetic fluxes and magnetic fields in the region including the parts affected by forces caused by magnetic moments. Another permanent magnet of opposing polarity to poles 28 and 30 can be moved by either motorized action or a solenoid actuator; for example inside the tool 10 deflecting the spatial distribution of magnetic field and associated magnetic flux lines away from the casing structure, reducing the magnetically coupling between the tool 10 and the casing 26 consequently affecting and reducing the attraction force coupling between tool 10 and casing 26. Another example of a moving part is a smaller magnetic part positioned by a motor or solenoid actuator for example to be pulled by attraction force towards the permanent magnet experiencing motion through a guide and pressing a rigid bar attached to a lever which rotates around a pivot (fulcrum) another structurally connected pad which assists with lifting off the tool load away from the casing with moment of force leveraging result effectively reducing the net magnetic force freeing the tool to move with less drag and friction with the casing. The permanent magnet such as a pad or moving could include an articulation to be energized and activated by this lever motion such as described above to assist its detachment from casing.

Net friction forces F_{F} can be caused by mutually attractive or repulsive forces that are caused by friction coefficient μ times the net force F_{N} that is normal to the contact surface. The friction coefficient μ can be optimally small on the order of 0.1 for smooth surfaces but can vary up to 0.7 for rough surfaces which may due to microscopic debris that is trapped and accumulated along depressions and gaps on the contact surface. The depressions and gaps can be microscope or visible, can impede movement of downhole tool 10 within casing 26. Friction forces F_{F} can be severe when more debris is encountered in horizontal or deviated wells, and particularly when moving the downhole tool 10 slowly. The approach described herein for countering the forces generated by permanent magnets can also be applied when permanent magnets are disposed within pads that are articulated by arms away from the downhole tool 10. Here, the magnetic field source 32 may be oriented in a plane tangential to the surface of casing 26 that is being engaged by the pad. Optionally, the magnetic field source 32 may be selectively operated in order to demagnetize the casing 26 (or tubular) in which the downhole tool 10 is disposed.

Downhole tool 10 can alternatively be deployed downhole via a wireline cable 18 and a tractor (not shown). Highly deviated and horizontal wells can become mechanically and operationally difficult due to the axially oriented fiction forces F_{A} of FIG. 1. Current level flowing in coil 34 could be adjusted in coordination with tractor operation and tractor pull load readings to improve efficiency by applying current to coil 34 only when tool 10 is held back by friction forces, which add load and mechanical load loss to the tractor operation. An energy efficiency optimization algorithm could be utilized by balancing energy applied with current in coil 34 and increased tractor mechanical load losses due to tool 10 friction and drag forces along casing 26 maximizing overall energy efficiency for the entire downhole tool string.

In a non-limiting example, a first spontaneous magnetic field M_{PM} formed by one of the magnets aligns elemental magnetic domains in material of the casing 26, therefore exhibiting a resulting net secondary magnetic moment induced in the casing 26. Both the tools's permanent and tubular's induced magnetic field moments can be represented by magnetic dipoles which interact generating a net attractive force F_{PM} between the downhole tool 10 and the tubular 26 in the case which has spatial distribution asymmetry of the interacting magnetic moments and corresponding fields in an around the tubular 26 specially when the tool 10 is not centralized within the tubular 26. Selectively countering or cancelling the permanent magnet's magnetic dipole moment fields associated with poles within the downhole tool extension with a controlled second magnetic dipole moment field consequently reduces the net secondary magnetic dipole moment induced in the tubular. The second magnetic held can be generated by coil 34 and be activated by selectively flowing current through coil 34 along a helical path distributed along the extension of poles 28, 29 of the permanent magnets within the downhole tool 10. The physical nature of the magnetic dipoles, magnetic fields and magnetic fluxes generated by either the magnetic dipole's electromagnet 34 or by magnetic dipole poles 28, 29 the permanent magnets can have spatially distributed additive and cancelling interaction. Reduction of the resulting net magnetic dipole strength of the tool 10 after the cancelling interaction between the permanent and secondary magnetic dipoles within the tool housing can substantially reduce the attractive force F_{PM} developed between the tool housing 16 and the tubular structure 26. The second controlled magnetic dipole field generated by electromagnet 34 can have a magnetic moment with the same magnitude as a magnetic dipole moment of the first magnetic field and oriented in an opposite direction. The second controlled magnetic dipole held polarity and intensity in electromagnet 34 can be manipulated by adjusting its current intensity and polarity in coil 34 to either reduce attractive forces to release the tool 10 or increase attractive forces to lock the tool in place by increased friction (FF) based on operational objectives. In one example, the second magnetic field has a magnetic moment with a lesser magnitude as a magnetic moment of the first magnetic field and oriented in an opposite direction. The resulting attractive force resulting from the first magnetic field can adhere the housing with the tubular's inner surface when in a deviated portion of the wellbore, with friction forces FF increased by the tool weight FW.

The present invention described herein, therefore, is well adapted to carry out any objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A method of operations in a wellbore comprising:
providing a downhole tool that comprises a housing and a permanent magnet;
deploying the downhole tool in the wellbore and within a tubular inserted in the wellbore so that a first magnetic field formed by the permanent magnet generates a force that attracts the downhole tool and the tubular inner surface; and
selectively countering the first magnetic field with a second magnetic field to reduce the force that attracts the housing with the tubular inner surface.

2. The method of claim 1, wherein the second magnetic field has a magnetic moment with the same magnitude as a magnetic moment of the first magnetic field and oriented in an opposite direction.

3. The method of claim 1, wherein the second magnetic field has a magnetic moment with a lesser magnitude as a magnetic moment of the first magnetic field and oriented in an opposite direction.

4. The method of claim 1, wherein the second magnetic field is formed by selectively flowing current through a coil along a helical path.

5. The method of claim 4, wherein the electrical current applied is constant, or has a time varying waveform, amplitude and frequency.

6. The method of claim 1, wherein the force generated by the first magnetic field adheres the housing with the tubular inner surface when in a deviated portion of the wellbore.

7. The method of claim 1, further comprising imaging within the borehole using the downhole tool.

8. The method of claim 7, wherein imaging is selected from the group consisting of nuclear magnetic resonance imaging, acoustic imaging, flux leakage imaging, and combinations thereof.

9. The method of claim 1, wherein the downhole tool is deployed on wireline.

10. A method of operations in a wellbore comprising:
operating, inside of the wellborn, a downhole tool that comprises a housing and a source of a first magnetic field within the housing;
moving the downhole tool within tubing that is inserted in the wellbore, so that the first magnetic field generates an attractive force between the downhole tool and an inner surface of the tubular; and
selectively forming a second magnetic field which counters the attractive force between die downhole tool and inner surface of the tubular.

11. The method of claim 10, wherein the source for the first magnetic field comprises a permanent magnet.

12. The method of claim 10, wherein the second magnetic field is formed by flowing electrical current along a helical path. cm 13. The method of claim 12, wherein the electrical current applied is constant, or has a time varying waveform, amplitude and frequency.

14. The method of claim 10, further comprising imaging a formation that surrounds the wellbore with an imaging system within the downhole tool.

15. A downhole tool for use in a wellbore comprising:
a housing;
a permanent magnet that forms a first magnetic field; and
an electromagnetic field source that selectively forms a second magnetic field which counters the first magnetic field.

16. The downhole tool of claim 15, further comprising a plurality of permanent magnets and a plurality of electromagnetic field sources.

17. The downhole tool of claim 15, wherein the electromagnetic field source comprises a coil of conductive material that forms a helical path for a flow of electrical current.

18. The downhole tool of claim 17, wherein the coil has a geometric extension that is similar to that of the permanent magnet and a geometric form factor that follows that of the permanent magnet.

19. The downhole tool of claim 15, wherein the housing attaches to wireline which supports the downhole tool within the wellbore.
